(19) United States
(12) Patent Application Publication
(10) Pub. No.: US 2015/0039248 A1
(43) Pub. Date: Feb. 5, 2015

(54) METHOD FOR DETERMINING A PARAMETER RELEVANT FOR CAUSING DAMAGE TO A STRUCTURE

(71) Applicant: Siemens Aktiengesellschaft, Munchen (DE)

(72) Inventors: JEAN-ANDRE MEIS, Duelmen (DE); JAN-DIRK REIMERS, Aachen (DE)

(21) Appl. No.: 14/448,375

(22) Filed: Jul. 31, 2014

(30) Foreign Application Priority Data
Aug. 1, 2013 (DE) 10 2013 215 157.8

(51) Int. Cl. G01M 7/02

(52) U.S. Cl. CPC G01M 7/025
USPC 702/42

(57) ABSTRACT

A method for determining a parameter relevant for the damage to a structure, such as machines, machine components and individual assemblies that are subject to vibration stresses is disclosed. A method for active or passive vibration damping that makes use of this method, and a structure having a device configured to perform the above methods is also disclosed.

### CROSS-REFERENCES TO RELATED APPLICATIONS

This application claims the priority of German Patent Application, Serial No. DE 10 2013 215 157.8, filed Aug. 1, 2013, pursuant to 35 U.S.C. 119(a)-(d), the content of which is incorporated herein by reference in its entirety as if fully set forth herein.

### BACKGROUND OF THE INVENTION

The present invention relates to a method for determining a parameter relevant for causing damage to a structure and to a method for active or passive vibration damping, in which the aforementioned method is executed. The invention also relates to a corresponding structure.

The following discussion of related art is provided to assist the reader in understanding the advantages of the invention, and is not to be construed as an admission that this related art is prior art to this invention.

During operation, structures, which can for example involve machines, machine components and also individual assemblies, are subject to vibration stresses. These stresses can lead to fatigue damage or even to complete destruction of the structure itself. Various options have therefore been developed for actively or passively reducing dynamic stresses.

A passive reduction of vibration stresses can be achieved via the mechanical design of the structure itself. The structure can for example include elastic coupling elements which reduce the transmission of vibrations from one assembly to another assembly arranged adjacent thereto. The elastic elements in such cases mostly have a damping effect which can additionally be modified in its damping characteristics. Thus couplings can be adapted in their damping to the frequency curve of the vibration of the drive train. A further option for passive damping is mass dampers or hydraulically-operating dampers.

The active reduction is possible by using an active closed-loop control, by means of which counter forces are explicitly introduced into the structure in order to attenuate the damaging vibrations. Many active closed-loop controls aim in such cases primarily to reduce the movement amplitudes themselves.

In the area of machine tools, adjustment drives and contour-following and workpiece-following systems, active closed-loop controls for reducing the movement amplitudes are used, with the aid of which in particular highly accurate positioning of the machines or systems is to be achieved. For this purpose the position, the speed or the acceleration are mostly measured on at least one point of the structure, after which the measured value is compared to a required value. The deviation of the actual value from the required value is then explicitly minimized via the closed-loop control. in such cases the problem can occur that the closed-loop control, in reducing movement amplitudes, which is intended to make highly accurate positioning possible, unintentionally increases the dynamic stresses of the structure. For industrial drive systems such a closed-loop control strategy is unfavorable since it can basically lead to higher material stresses through increased application of force and thus to greater damage to the structure.

As well as closed-loop control methods which are used to increase positional accuracy, methods are also known for reducing inherently-excited forms of vibration, which are system-immanent, during operation. Basically two options are available here. The vibration excitation can be avoided or the vibrations excited are compensated for. For compensation the vibration variables are captured and the form of vibration is compensated for via a closed-loop control by said control's actuator options. With this closed-loop control method too it can occur that the compensation for the vibration at one point leads to a summing of the vibrations and forces at another point. This problem can be counteracted through a suitable choice of transducer and its local position. However such closed-loop control methods only provide the option of reducing or preventing damage resulting from resonance through the use of vibration compensation. A reduction of stresses caused as a result of outside excitations or by the compensation movement of the closed-loop control process itself is not possible. Load impacts continue to occur, which can give rise to damage. The avoidance of vibration excitation operates via active adjustment variables, which avoid the area at risk of vibration or avoid it as an operating parameter (blanking). Vibrations excited from outside can likewise not be taken into account here.

It would therefore be desirable and advantageous to obviate prior art shortcomings and to provide an improved method for damage analysis as well as an improved method for reducing vibration stresses.

### SUMMARY OF THE INVENTION

According to one aspect of the present invention, a method for determining a parameter relevant for causing damage to a structure includes the steps of:
(a) measuring a local stress on at least one point of the structure as a function of time;
(b) generating a stress-time function;
(c) breaking down of the stress-time function into individual stress cycles;
(d) determining a frequency of the stress cycles and at least one additional classification parameter of the stress cycles;
(e) assigning the stress cycles to different frequency classes as a function of the frequency of the stress cycles;
(f) generating a collective for the stress cycles in each frequency class by carrying out a single-parameter or a multi-parameter classification method;
(g) determining a relevance of the collective of each frequency class for causing damage to the structure; and
(h) determining the particular frequency class that is most relevant for causing damage to the structure.

The underlying idea behind the present invention is to capture the vibration stress on a structure and evaluate it such that stress-related damage is assigned to specific frequencies or specific frequency ranges of the stress cycles respectively, i.e. the individual vibration cycles of the stress-time function. Under real conditions structures are generally subject to vibration stresses in which amplitude, mean value and frequency vary over time. In such cases it has been shown that some frequencies play a greater role in the stress-related damage to the structure than others. The inventive assignment of damage to frequency enables particularly critical frequencies or frequency ranges to be identified. This evaluation takes place independently of the otherwise usual classification of the frequencies according to inherent or outside excitation, since this does not absolutely have to be linked to the damage effect of the vibration amplitude.

For this purpose, first of all in step (a) of the inventive method a local stress is measured as a function of time on at least one point of the structure. The measurement can be made for example by means of strain gages or in a non-contact fashion using other devices known in this context.

In step (b) a stress-time function is created, which is then broken down into the individual stress cycles, i.e. into the individual vibrations. The frequency of the stress cycles, which corresponds to the reciprocal value of the time period, is defined and expediently stored. The stress cycles are then assigned, as a function of their frequency, to different frequency classes, which preferably cover the entire frequency range over which the frequencies of the stress cycles of the stress-time function extend. As a result a sorting of the stress cycles in accordance with their frequencies is performed, wherein the information about their actual order in the stress-time function is ignored.

At least one further classification parameter is determined in addition to the frequency of the stress cycles. For statistical evaluation of the stress cycles, a single-parameter or multi-parameter classification method is then performed, wherein for the single-parameter classification method a further classification parameter, which can for example involve the stress amplitude σₐ of the stress cycles, is included, and for a two-parameter classification method two further classification parameters are determined which can for example involve the stress amplitude σₐ and the mean load σₘ of the stress cycles. By performing the classification method a collective, i.e. a frequency distribution of the stress cycles in relation to the classification parameter or parameters is obtained, and this is done for each of the frequency classes.

The frequency distribution may be obtained in such cases by the stress cycles being classified in a known manner into classes by subdividing the range or the ranges over which the captured classification parameters of the stress cycles extend. The result obtained is how many stress cycles lie in the respective parameter class. If a single-parameter classification method is performed a 2D frequency distribution is obtained as the collective. For a two-parameter classification method a 3D frequency matrix is produced as the collective.

The rainflow counting method, may advantageously be used for example as the two-parameter classification method. In the 3D frequency matrix the stress amplitudes subdivided into classes are then plotted for example along the X axis, the mean load subdivided into classes is plotted along the Y axis and the corresponding number of stress cycles is plotted along the Z axis.

For the collective created for each frequency class in step (f) of the inventive method, it is determined in step (g) what relevance these have for the damage to the structure. This is expediently done by a value representing the damage to the structure being determined for the respective collective.

According to an advantageous feature of the present invention, the value representing the damage to the structure is determined by including a reference Wöhler curve assigned to the structure which can especially involve a measured or synthetically created reference Wöhler curve.

In the Wöhler curve the stress amplitude σₐ is plotted against the number of stress cycles able to be borne at this amplitude, i.e. against the number of stress cycles which the structure can bear at the respective stress amplitude σₐ until the structure fails, for example by breaks or cracks forming. The Wöhler curve is generally created for a sinusoidal vibrating load for a constant mean load σₘ.

From the reference Wöhler curve belonging to the structure part damage is then determined in a known way for the subclasses of the respective collective, via which in turn the overall damage of the collective can be determined. This is carried out for the collective of each frequency class.

According to another advantageous feature of the present invention, the value representing the damage to the structure may be determined by carrying out a damage accumulation method, wherein the method especially refers back to the original Miner rule or the modified Miner rule or the consequent Miner rule or to a non-linear damage hypothesis. After part damages have been determined using the Wöhler curve, these can be accumulated in order to then obtain a value representing the damage to the structure for the respective collective.

When the rainflow counting method is carried out as the classification method, in accordance with an embodiment of the invention in step (g), as part of carrying out the damage accumulation method, the damage is summed over the stress amplitude and the mean load.

As an alternative to the rainflow method, the load duration counting method may be performed as a classification method. In principle, within the framework of the inventive method, any classification method can be employed by means of which collectives can be created for the individual frequency classes, on the basis of which a damage relevance can then be determined.

After the relevance of the collective of each frequency class has been determined for the damage to the structure in step (g) of the inventive method, in step (h) the frequency class is determined which is of most relevance for the damage to the structure. This involves the frequency class in which for example the value representing the damage is at its greatest, which can be determined by comparing the values of all frequency classes.

According to another advantageous feature of the present invention, in step (d), the stress amplitude and the average load of the stress cycles may determined, in addition to the frequency, as further classification parameters, and especially in step (f) the rainflow counting method may be performed as the classification method.

According to another advantageous feature of the present invention, in step (a) the locally measured stress on the structure on at least one point may be converted to at least one other point of the structure. This is especially advantageous if a point of the structure is to be investigated that is difficult to access for stress measurement. Expediently, within the framework of the inventive method, the stress-time function is created for a critical point of the structure, i.e. a point at which for example damage is likely to occur soonest. A critical point can for example be a shoulder on the structure, an indentation or the like.

At least one critical point of the structure can especially be identified by performing, after step (a), a local structure analysis, especially based on a finite element method or a multi-body system method. A stress-time function is then created in the expedient way for the at least one critical point.

According to another aspect of the present invention, a method for active or passive vibration damping of a structure includes the following steps:
(aa) carrying out the aforedescribed method, and
(bb) explicitly damping at least one frequency which lies within the frequency class determined in step (g) of the aforedescribed method.

By carrying out the inventive method for determining a parameter relevant for the damage to a structure, the frequency class is determined which is the most relevant for the damage to the structure. Based on this result, an active closed-loop control, open-loop control or passive manipulation for vibration damping on the structure is performed, in order to explicitly attenuate one or more especially critical frequencies which contribute the most to the damage to the structure. As a result the especially damage-relevant vibrations are suppressed and the reliability of the structure is improved.

An explicit constructional change to the structure can also be deemed to be a passive manipulation and relates to the tuning of the coupling elements, fill level of the hydraulic dampers or mass damper tuning. Under some circumstances a limitation of the parameterization of a converter can also be judged as a passive method, as can the limitation of the short-circuit current of a transformer via the saturation.

Since critical frequencies can be readily identified using the method of the present invention, non-critical vibrations can advantageously be tolerated in the closed-loop control. This is above all of advantage if the complete filtering-out of frequency bands is not desired.

The inventive method for determining a parameter relevant for the damage to the structure and the inventive method for active vibration damping of a structure are carried out in real time in a development of the invention.

According to another aspect of the invention, a structure includes a device configured execute the inventive method for active vibration damping of the structure.

According to an advantageous feature of the present invention, the structure may include a digital signal processor or a microcontroller or a Field-Programmable-Gate-Array. These electronic elements are especially suitable for carrying out the inventive method, above all for carrying out the computations required in steps (b) to (h) in a sufficiently short time, so that in particular real time operation becomes possible.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of an apparatus with motor, drive machine, transmission and a device which is configured to execute the method according to the present invention for determining a parameter relevant for the damage to a structure, and

FIG. 2 shows a schematic diagram of a section of a stress-time function.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

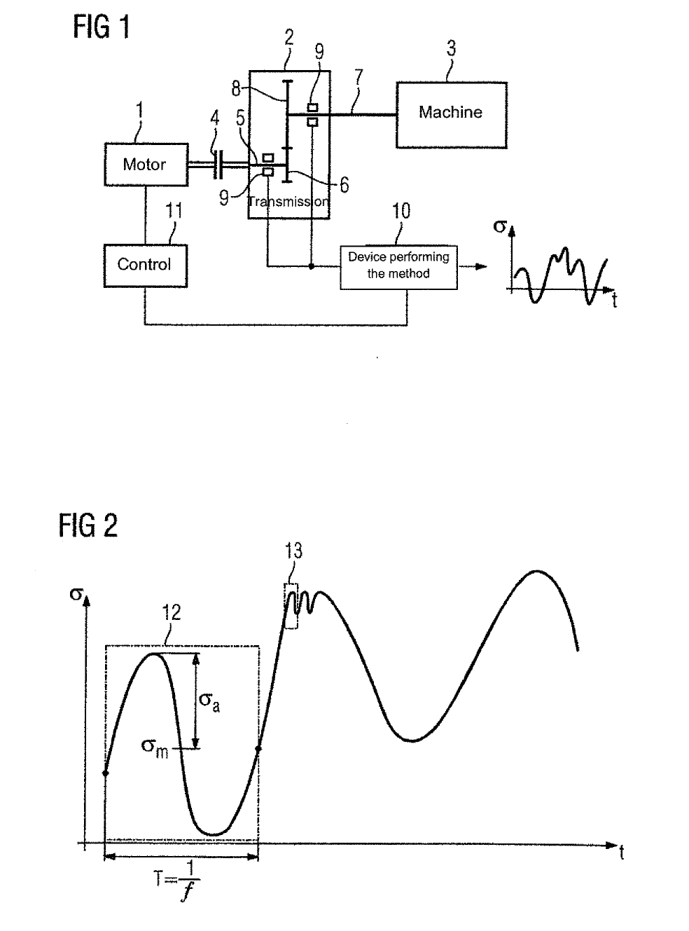

Turning now to the drawing, and in particular to FIG. 1, there is shown a motor 1 which is connected to a working machine 3 via a transmission 2. A clutch 4, via which the connection between the motor 1 and the working machine 3 can be connected and disconnected, is provided between the motor 1 and the transmission 2.

The transmission 2 includes a first toothed wheel 6 held on an input shaft 5 and a second toothed wheel 8 held on an output shaft 7 and meshing with the first toothed wheel 6. Measurement points 9 are provided in each case on the shafts 5 and 7, at which the local stress on the shafts 5 and 7 can be measured via strain gages, which is not illustrated in detail in FIG. 1.

The measurement points 9 are connected to a device 10 which is configured for carrying out the inventive method for determining a parameter relevant for the damage to a structure, in this case the transmission 2. The device 10 includes a Field Programmable Gate Array (not shown in FIG. 1).

A closed-loop control or adjustment device 11 is also provided, which is connected on the input side to the device 10 and on the output side to the motor 1. In a non-restrictive manner, 11 can also be understood as a control device, in that only control data is provided which does not act as closed-loop control data.

Within the framework of carrying out the inventive method for active or passive vibration damping of a structure, in the present case of the transmission 2, first of all the local stress is measured as a function of time on the transmission shafts 5 and 7 of the transmission 2 via the strain gage provided at the measurement points 9.

On the basis of the measurement results a stress-time function is created in which—as FIG. 2, which contains a section of the stress-time function in a schematic diagram—the stress σ over the time t is shown. The stress-time function contains a plurality of vibration cycles with different vibration amplitudes σₐ, mean loads σₘ and time periods T.

The stress-time function is broken down into the individual stress cycles, i.e. its individual vibration cycles. FIG. 2 shows two stress cycles 12 and 13 of the stress-time function highlighted by a frame surrounding said cycles. The first stress cycle 12 here has a significantly greater time period T₁ than the second stress cycle 13, the time period of which is not explicitly identified in FIG. 2.

In the next step of the inventive method the frequency f of the individual stress cycles, which corresponds to the reciprocal value of the time period T thereof, is determined. For the section shown in FIG. 2 of the stress-time function the frequency f₁ of the first stress cycle 13 is far lower than the frequency f₂ of the second stress cycle 15, which is the result of a comparison of the two stress cycles 12 and 13.

As well as the frequency of the stress cycles, two further classification parameters, in this case the stress amplitude σₐ and the mean load σₘ of the individual stress cycles of the stress-time function, are determined and stored.

The stress cycles are then assigned to different frequency classes as a function of their frequency. The entire frequency range over which the frequencies of the stress cycles extend is subdivided into the frequency classes in which the assignment is made. The frequency range extends in a non-limiting manner between 0.1 Hz and 10 kHz, preferably however between 1 and 1000 Hz, especially between 10 and 100 Hz. This range might provide the preferred range for certain machines. Furthermore these frequency ranges can be subdivided into 1000 classes, preferably 256, but especially between 10 and 100 classes. These classes do not have to evenly divide the frequency range but can be of different sizes. A sorting of the frequency cycles in accordance with their frequency is thus obtained, wherein the information about the actual sequence of the frequency cycles in the stress-time function is ignored.

Subsequently, in each frequency class for the stress cycles, by carrying out a two-parameter classification method, in this case the rainflow counting method, a collective, i.e. the frequency distribution of the stress cycles is created in relation to the two classification parameters stress amplitude σₐ and mean load σₘ. The frequency distribution, i.e. the collective, is obtained in this case in that the stress cycles are counted in a known manner as a function of their respective stress amplitude σₐ and their mean load σₘ in the corresponding parameter subclasses. The result obtained is how many stress cycles fall into the respective parameter subclasses. Since the rainflow counting method involves a two-parameter classification method, a 3D frequency matrix is obtained as the collective, in which in the present example the stress amplitude subdivided into classes is plotted along the X axis, the average load subdivided into classes is plotted along the Y axis and the associated number of stress cycles is plotted along the Z axis

In accordance with the invention such a 3D frequency matrix is created for each of the frequency classes, wherein the stress cycles of the corresponding frequency are taken into account in each matrix. In an advantageous manner, with this form of evaluation the limit frequency of the detection chain can be taken into consideration such that the amplitude of the vibration mapped incorrectly with increasing frequency can be corrected by the amplitude being able to be computed in accordance with its attenuation in relation to the limit frequency. This leads to a more truly mapped evaluation of the load amplitudes.

Subsequently, for the collectives created, the relevance that said collectives have for the damage to the transmission 2 is determined. This is done in the present exemplary embodiment by a value representing the damage to the transmission 2 being determined for the respective collective. For this a reference Wöhler curve assigned to the transmission 2 is included in which the stress amplitude σₐ is plotted against the number of stress cycles able to be borne at this amplitude, i.e. the number of stress cycles which the transmission can bear at the respective stress amplitude σₐ until it fails, for example by breaks or cracks forming. Part damage is determined in a manner known per se for the subclasses of each collective. Contained in the subclasses in each case is a concrete number of stress cycles, which have a stress amplitude σₐ, which lie in a range of stress amplitudes belonging to the subclasses, and a mean load σₘ, which lies in the mean load range belonging to this subclass, so that part damage can be directly obtained from the Wöhler curve, by the number in the class with the bearable number of stress cycles being related, in concrete terms being divided up, by said class in accordance with its distribution. In its turn an overall damage for the collective is determined from the part damage, wherein a damage accumulation method is carried out for this. In this case there is recourse for this to the original Miner rule.

As a result a damage value is obtained for each collective, i.e. for each frequency class.

In the next step the frequency class which is most relevant for the damage to the transmission 2 is determined. This is done here by the damage values of the individual collectives of the frequency classes being compared with one another and the greatest damage value being determined using this method.

After the most relevant frequency class has been determined, this information is passed on by the device 10 to the closed-loop control or adjustment device 11 connected thereto. Finally, by means of the closed-loop control or adjustment device 11, at least one frequency which lies within the previously determined frequency class which is the most relevant for the damage is explicitly attenuated in that the motor 1, or the converter unit which in its turn activates the motor, connected to the closed-loop control device 9, is activated in the appropriate way.

As a result only the vibrations especially relevant for the damage are suppressed and the reliability of the structure is improved. In such cases it is possible in accordance with the invention for non-critical vibrations to be able to be tolerated.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for determining a parameter relevant for causing damage to a structure, the method comprising:
a) measuring a local stress on at least one point of the structure as a function of time;
b) generating a stress-time function;
c) breaking down of the stress-time function into individual stress cycles;
d) determining a frequency of the stress cycles and at least one additional classification parameter of the stress cycles;
e) assigning the stress cycles to different frequency classes as a function of the frequency of the stress cycles;
f) generating a collective for the stress cycles in each frequency class by carrying out a single-parameter or a multi-parameter classification method;
g) determining a relevance of the collective of each frequency class for causing damage to the structure; and
h) determining the particular frequency class that is most relevant for causing damage to the structure.

2. The method of claim 1, wherein the relevance of the collective is determined in step (g) by determining a value for the collective representing the damage to the structure.

3. The method of claim 2, wherein the value representing the damage to the structure is determined by including a reference Wöhler curve associated with the structure.

4. The method of claim 3, wherein the reference Wöhler curve comprises a measured or synthetically-created reference Wöhler curve.

5. The method of claim 3, wherein the value representing the damage to the structure is determined by executing a damage accumulation method based on a rule selected from an original Miner rule, a modified Miner rule, a consequent Miner rule, and a non-linear damage hypothesis.

6. The method of claim 1, further comprising determining in step (d), in addition to the frequency of the stress cycles, two additional classification parameters of the stress cycles.

7. The method of claim 6, further comprising determining in step (d), in addition to the frequency of the stress cycles, a stress amplitude and a mean load of the stress cycles as additional classification parameters.

8. The method of claim 7, further comprising performing in step (f) a rainflow counting method as the classification method.

9. The method of claim 5, further comprising
determining in step (d), in addition to the frequency of the stress cycles, a stress amplitude and a mean load of the stress cycles as additional classification parameters, and
summing, in step (g), when the damage accumulation method is executed, the damage over the stress amplitude and the mean load.

10. The method of claim 1, wherein in step (f) a load-duration-counting method is performed as the classification method.

11. The method of claim 1, further comprising converting, in step (a), a stress on the structure measured locally on at least one point of the structure to at least one other point of the structure.

12. The method of claim 1, further comprising performing, after step (a), a local structure analysis based on a finite-element method or a multi-body-system method.

13. The method of claim 12, further comprising identifying at least one critical point of the structure based on the local structure analysis.

14. The method of claim 13, further comprising generating, in step (b), a stress-time function for the at least one critical point of the structure.

15. A method for active or passive vibration damping of a structure, comprising:
a) measuring a local stress on at least one point of the structure as a function of time;
b) generating a stress-time function;
c) breaking down of the stress-time function into individual stress cycles;
d) determining a frequency of the stress cycles and at least one additional classification parameter of the stress cycles;
e) assigning the stress cycles to different frequency classes as a function of the frequency of the stress cycles;
f) generating a collective for the stress cycles in each frequency class by carrying out a single-parameter or a multi-parameter classification method;
g) determining a relevance of the collective of each frequency class for causing damage to the structure; and
h) determining the particular frequency class that is most relevant for causing damage to the structure, and
i) intentionally damping at least one frequency located in the frequency class determined in step (g).

16. The method of claim 1, wherein the method is carried out in real time.

17. A structure, comprising a device configured to execute a method for determining a parameter relevant for causing damage to a structure, the method comprising:
(a) measuring a local stress on at least one point of the structure as a function of time;
(b) generating a stress-time function;
(c) breaking down of the stress-time function into individual stress cycles;
(d) determining a frequency of the stress cycles and at least one additional classification parameter of the stress cycles;
(e) assigning the stress cycles to different frequency classes as a function of the frequency of the stress cycles;
(f) generating a collective for the stress cycles in each frequency class by carrying out a single-parameter or a multi-parameter classification method;
(g) determining a relevance of the collective of each frequency class for causing damage to the structure; and
(h) determining the particular frequency class that is most relevant for causing damage to the structure.

18. The structure of claim 17, further comprising a digital signal processor or a microcontroller or a Field-Programmable-Gate-Array.
